(19) United States
(12) Patent Application Publication
(10) Pub. No.: US 2011/0320857 A1
(43) Pub. Date: Dec. 29, 2011

(54) BOTTOM-UP MULTILAYER NETWORK RECOVERY METHOD BASED ON ROOT-CAUSE ANALYSIS

(75) Inventors: Tae Hyun Kwon, Andong (KR); Hyung Seok Chung, Daejeon (KR); You Hyeon Jeong, Daejeon (KR); Ho Young Song, Daejeon (KR); Young Wook Cha, Daegu (KR); Choon Hee Kim, Daegu (KR); Jin Nyun Kim, Cheongsong-gun (KR)

(73) Assignee: Electronics and Telecommunications Research Institute, Daejeon (KR)

(21) Appl. No.: 13/167,347

(22) Filed: Jun. 23, 2011

(30) Foreign Application Priority Data
Jun. 23, 2010 (KR) 10-2010-0059565

(51) Int. Cl. G06F 11/07

(52) U.S. Cl. 714/2; 714/E11.023

(57) ABSTRACT

A bottom-up (or upward) multilayer network recovery method and apparatus based on a root-cause analysis are disclosed to quickly and accurately perform a recovery operation. The bottom-up multilayer network recovery method based on a root-cause analysis includes: simultaneously counting, by a fault detection layer, a root-cause analysis (RA) time and a hold-off (HO) time, upon detecting an occurrence of a fault; performing, by the fault detection layer, a root-cause analysis during the RA time to recognize a layer in which a root-cause has occurred; when the root-cause has occurred in the fault detection layer, immediately recovering the fault by the fault detection layer, and when a root-cause has occurrence in a lower layer, waiting for the HO time until such time as the lower layer can recover the fault; and when the fault has not been recovered even after the HO time has lapsed, recovering the fault by the fault detection layer.

### CROSS-REFERENCE TO RELATED APPLICATIONS

This application claims the priority of Korean Patent Application No. 10-2010-0059565 filed on Jun. 23, 2010, in the Korean Intellectual Property Office, the disclosure of which is incorporated herein by reference.

### BACKGROUND OF THE INVENTION

1. Field of the Invention

The present invention relates to a method for recovering a multilayer network, such as a packet-optic convergence network and, more particularly, to a bottom-up (or upward) multilayer network recovery method and apparatus based on a root-cause analysis capable of recognizing a layer having a root-cause through a root-cause analysis process and quickly and accurately performing a recovery operation based on the recognized layer.

2. Description of the Related Art

In the related art bottom-up multilayer network recovery method (or scheme), recovery starts from the lowermost layer or the lowermost layer in which a fault is detected, and after the fault of the lowermost layer is completely recovered, and that of an upper layer is sequentially recovered. A fault at an upper layer, not recovered by the recovery of the lower layer, may be recovered by the upper layer itself. Namely, when the lower layer is not able to recover a fault of the upper layer, it hands over the authority for recovery (recovery control authority or a recovery control right) to the upper layer.

Bottom-up multilayer network recovery methods may be divided into a scheme of using a hold-off time and a scheme of using a recovery token signal depending on how and when the recovery authority is handed over from the lower layer to the upper layer.

For a multilayer recovery, a bottom-up multilayer network recovery method based on a standby time (or a waiting time) is currently largely employed for the reasons of easiness in implementation and standardization. Namely, the bottom-up multilayer network recovery method can be simply and easily implemented.

FIG. 1 illustrates a recovery cycle of the bottom-up multilayer network recovery method based on a standby time according to the related art.

As shown in FIG. 1, in the bottom-up multilayer network recovery method, generally, a defect is detected at a time T1, and when the defective state continues for longer than a failure declaration (FD) period, a fault generation is declared at a time T2. Then, recovery starts from the lowermost layer or from a layer in which the fault generation was detected. When a fault is detected at an upper layer, the upper layer waits for a hold-off (HO) time till a time T3 during which a recovery procedure of the lower layer is performed. When the fault is not resolved even after the lapse of HO time, the upper layer recovers the fault during a recovery operation (RO) time. Namely, the fault in the upper layer not recovered by the recovery of the lower layer can be recovered by the upper layer (T4).

The related art bottom-up multilayer network recovery method is advantageous in that the recovery procedure is performed by appropriate units (granularity). Namely, a recovery by a lumpy unit (e.g., a light path of an optical transmission layer) can be made at the lowermost layer, and subsequent recoveries can be sequentially made by the gradually reduced units (e.g., a path of a packet transmission layer) in the follow-up steps.

However, even when a fault occurs in the upper layer, the upper layer must wait for the HO period. Namely, the upper layer cannot start its recovery procedure until the HO time expires. In other words, regardless of where a fault occurs, the upper layer must always wait for the HO period and then perform its recovery procedure.

Thus, in the related art, even when a fault occurs in the upper layer, rather than in the lower layer, a fault recovery by the upper layer can be started after the lapse of the HO time, unnecessarily lengthening the recovery completion time. This brings about vital results in which a service of real time traffic requiring high resilience cannot be provided or a service is interrupted.

### SUMMARY OF THE INVENTION

An aspect of the present invention provides a bottom-up multilayer network recovery method and apparatus based on a root-cause analysis capable of recognizing a layer having a root-cause through a root-cause analysis process and performing recovery, starting from the corresponding layer, to thus quickly and accurately perform the recovery operation.

According to an aspect of the present invention, there is provided a bottom-up multilayer network recovery method based on a root-cause analysis, including: simultaneously counting, by a fault detection layer, a root-cause analysis (RA) time (or RA period) and a hold-off (HO) time (or HO period), upon detecting an occurrence of a fault; performing, by the fault detection layer, a root-cause analysis during the RA time to recognize a layer in which a root-cause has occurred; when the root-cause has occurred in the fault detection layer, immediately recovering the fault by the fault detection layer, and when a root-cause has occurrence in a lower layer, waiting for the HO time until such time as the lower layer can recover the fault; and when the fault has not been recovered even after the HO time has lapsed, recovering the fault by the fault detection layer.

In the recognizing of the layer in which the root-cause has occurred, whether or not the root-cause has occurred in the fault detection layer or in the lower layer of the fault detection layer may be recognized by analyzing a connection (or a correlation, an association) between the layer in which the root-cause has occurred and the layer in which a secondary fault has occurred.

The method may further include: when the layer in which the root-cause has occurred is not recognized according to the root-cause analysis results, checking a quality of service (QoS) grade of traffic; when the QoS grade of the traffic is higher than a pre-set value, immediately recovering the fault by the fault detection layer; and when the QoS grade of the traffic is lower than the pre-set value, determining, by the fault detection layer, whether to recover the fault after waiting for the HO time.

The QoS grade of the traffic may be determined in consideration of one or more of QoS of the traffic, class of service (CoS), service level agreement (SLA), and traffic priority level.

The RA time may be shorter than the HO time, and the HO time may be determined according to an equation: “HO=Rt−Dt+Gt, Dt=t2−t1, Gt=t4−t3”, wherein Rt is a time required for recovering the lower layer, t1 is a point in time at which the occurrence of the fault of the lower layer is declared, t2 is a point in time at which the occurrence of the fault of the lower layer is declared (or a point in time at which the upper layer starts counting of the HO time), t3 is an estimated point in time at which the recovery of the fault at the lower layer is completed, and t4 is a point in time at which the counting of the HO time by the upper layer is terminated.

According to an aspect of the present invention, there is also provided a multilayer fault recovery apparatus applied to a communication device constituting a multilayer network, including: a fault detection unit declaring the occurrence of a fault upon detecting the fault; a timer counting a root cause analysis (RA) time and a hold-off (HO) time when the fault detection unit declares the occurrence of the fault; a root-cause analyzing unit recognizing a layer in which the root-cause has occurred during the RA time; and a fault recovery unit immediately recovering a fault when the root-cause (i.e., the fault) has occurred in a layer managed (or administered) by the communication device, or recovering the fault only when the fault is not recovered even after the fault recovery unit waits for the HO time (namely, even after the fault recovery unit has been in standby during the HO time) to allow the lower layer to recover the fault during the HO time.

When the layer in which the root-cause has occurred is not recognizable, the fault recovery unit may check the QoS grade of traffic and immediately recover the fault with respect to traffic whose QoS grade is higher than a pre-set value, and with respect to traffic whose QoS grade is lower than the pre-set value, the fault recovery unit may wait for the HO time, and then recover the fault only when the fault is not recovered even with the lapse of the HO time. The fault recovery unit may determine the QoS grade of the traffic in consideration of one or more of QoS of the traffic, class of service (CoS), service level agreement (SLA), and traffic priority level.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view illustrating a recovery cycle of a bottom-up multilayer network recovery method according to the related art;

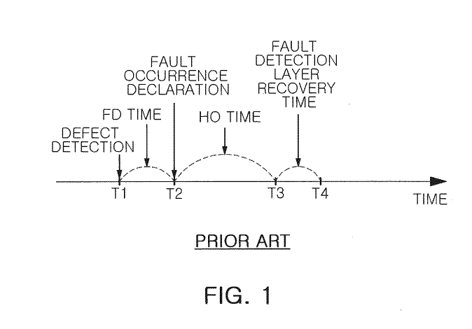

FIG. 2 is a view illustrating an example of a multilayer network to which a bottom-up multilayer network recovery method based on a root-cause analysis according to an exemplary embodiment of the present invention can be applicable;

FIG. 3 is a schematic block diagram of a multilayer fault recovery apparatus according to an exemplary embodiment of the present invention;

FIG. 4 is a flow chart illustrating the process of the bottom-up multilayer network recovery method based on a root-cause analysis using the multilayer fault recovery apparatus according to an exemplary embodiment of the present invention;

FIG. 5 is a view illustrating a recovery cycle of the bottom-up multilayer network recovery method based on a root-cause analysis according to an exemplary embodiment of the present invention; and

FIG. 6 is a view illustrating the relationship between a point in time at which a fault occurrence is declared and a recovery time in order to determine a hold-off (HO) time by an upper layer.

### DETAILED DESCRIPTION OF THE PREFERRED EMBODIMENT

The present invention may be modified variably and may have various embodiments, particular examples of which will be illustrated in drawings and described in detail.

However, it should be understood that the following exemplifying description of the invention is not intended to restrict the invention to the specific forms of the present invention but rather the present invention is meant to cover all modifications, similarities and alternatives which are included in the spirit and scope of the present invention.

While terms such as “first” and “second,” etc., may be used to describe various components, such components must not be understood as being limited to the above terms. The above terms are used only to distinguish one component from another. For example, a first component may be referred to as a second component without departing from the scope of rights of the present invention, and likewise a second component may be referred to as a first component. The term “and/or” encompasses both combinations of the plurality of related items disclosed and any item from among the plurality of related items disclosed.

When a component is mentioned as being “connected” to or “accessing” another component, this may mean that it is directly connected to or accessing the other component, but it is to be understood that another component may exist therebetween. On the other hand, when a component is mentioned as being “directly connected” to or “directly accessing” another component, it is to be understood that there are no other components in-between.

The terms used in the present application are merely used to describe particular embodiments, and are not intended to limit the present invention. An expression used in the singular encompasses the expression of the plural, unless it has a clearly different meaning in the context in which it is used. In the present application, it is to be understood that the terms such as “including” or “having,” etc., are intended to indicate the existence of the features, numbers, operations, actions, components, parts, or combinations thereof disclosed in the specification, and are not intended to preclude the possibility that one or more further features, numbers, operations, actions, components, parts, or combinations thereof may exist or may be added.

Unless otherwise defined, all terms used herein, including technical or scientific terms, have the same meanings as those generally understood by those having an ordinary knowledge in the field of the art to which the present invention belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

Embodiments of the present invention will be described below in detail with reference to the accompanying drawings, where those components are rendered using the same reference number that are the same or are in correspondence, regardless of the figure number, and redundant explanations are omitted.

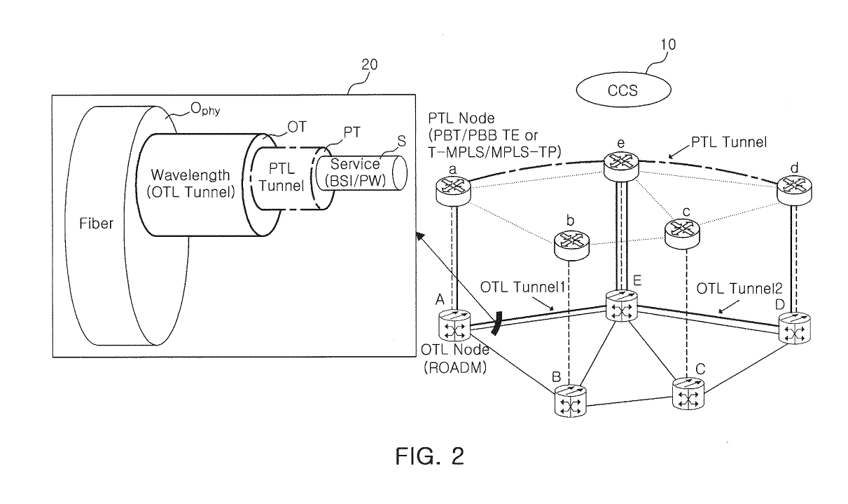

FIG. 2 is a view illustrating an example of a multilayer network to which a bottom-up multilayer network recovery method based on a root-cause analysis according to an exemplary embodiment of the present invention can be applicable.

As shown in FIG. 2, the multilayer network has a structure in which an optical network (e.g., OADM (Re-configurable Optical Add-Drop Multiplexer), OXC (Optical Cross Connect)) and a packet transport network (e.g., PBT/PBB-TE (Provider Backbone Transport/Provider Backbone Bridge-Traffic Engineering), T-MPLS/MPLS-TP (Transport MPLS/MPLS Transport Profile)) are integrated into a single network, and it may perform a centralized recovery control server function through a CCS (Centralized Control Server) 10.

To this end, it is noted that optical transport layer (OTL) nodes A to E constituting the optical network and packet transport layer (PTL) nodes a to e are connected by optical cables 20, each having one or more optical channels (i.e., wavelengths or OTL Tunnels). For example, one or more working optical cables and one or more backup optical cables are installed between the OTL nodes A to E and the PTL nodes to connect them.

The optical channel of each of the optical cables 20 includes one or more PTL Tunnels (PT). In this case, when the PTL nodes a to e are implemented as PBT/PBB-TE, the PTL Tunnel (PT) may be used as terms such as trunk, TESI, tunnel, or the like, and when the PTL nodes a to e are implemented as T-MPLS/MPLS-TP, the PTL Tunnel (PT) may be used as terms such as LSP, tunnel, or the like. Namely, the wavelength (OT) is configured as a wavelength path in the aspect of hop-by-hop (e.g., OTL nodes A to E), while it becomes an OTL Tunnel such as a wavelength path or a light path in the aspect of the intra-ends (the nodes a-A-E-e). The OTL Tunnel is configured as a logical link of the PTL. In other words, the PTL Tunnel formed by connecting the PTL nodes a-e-d includes an OTL Tunnel1 (a-A-E-e) and an OTL Tunnel2 (e-E-D-d) in actuality.

The PTL Tunnel (PT) includes one or more backbone service instances (BSI) or pseudo-wires (PW) in order to provide a service (e.g., a metro Ethernet service). Specifically, the BSI is included in the case of PBT/PBB-TE, and the PW is included in the case of T-MPLS/MPLS-TP.

In the multilayer network having the foregoing structure, a single root-cause generated from a lower layer triggers tens or hundreds of secondary faults at an upper layer.

Thus, in the related art, when a fault generated at an upper layer is detected, recovery is unconditionally performed starting from a lower layer to solve the fault detected in the upper layer. Thus, because recovery is sequentially performed on the layers, starting from the lower layer, even with the fault generated in the upper layer, not at the lower layer, a time required for completing the recovery is lengthened more than necessary.

The present invention performs a root-cause analysis to recognize a layer having a root-cause, and in this case, when a root-cause is generated at an upper layer, the root-cause (or fault) in the upper layer is immediately recovered, without waiting for a recovery of a lower layer, thereby prevent an unnecessary increase in the recovery completion time.

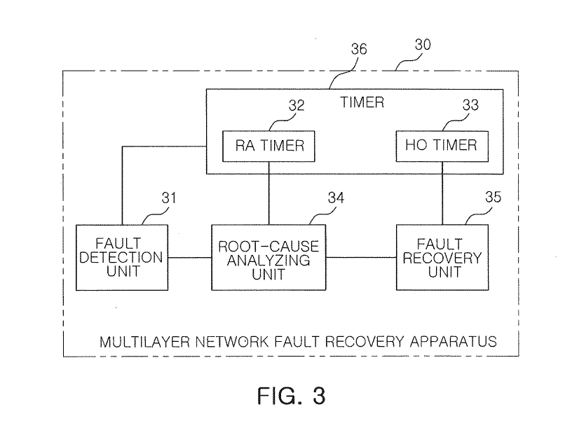

FIG. 3 is a schematic block diagram of a multilayer fault recovery apparatus according to an exemplary embodiment of the present invention. The multilayer fault recovery apparatus may be provided as a single independent device or in the form of an internal module in the communication nodes such as the PTL nodes a to e and the OTL nodes A to E or in the CCS 10.

With reference to FIG. 3, the multilayer fault recovery apparatus 30 may include a fault detection unit 31 detecting a generated defect, and declaring a fault generation (or the presence of the fault) when the defective state continues for a failure declaration (FD) time, a timer 36 counting a root-cause analysis (RA) time and a hold-off (HO) time through an RA timer 32 and an HO timer 33 when the fault detection unit 31 declares the fault generation, a root-cause analyzing unit 34 recognizing a layer in which a root-cause has occurred during an RA time, and a fault recovery unit 35 immediately recovering a fault when the root-cause has occurred in a layer (i.e., a fault detection layer) managed by the communication device according to the analysis results obtained by the root-cause analyzing unit 34, or recovering a fault only when the fault is not recovered even after the fault recovery unit waits for the HO time to allow a lower layer to recover the fault during the HO time.

The fault recovery unit 35 may have an additional function of recognizing the quality of service (QoS) grade of traffic and differentially recovering a fault according to the QoS grade of the traffic, if necessary, in a case in which a layer having a root-cause is not clearly recognized. Namely, when the QoS grade of the traffic is higher than a pre-set value, the fault recovery unit 35 immediately recovers the corresponding fault at the fault detection layer, and when the QoS grade of the traffic is lower than the pre-set value, the fault recovery unit waits for the HO time to allow the lower layer to recover the fault during the HO time, and then if the lower layer fails to recover the fault, the fault recovery unit 35 may recover. This aims to prevent or minimize damage such as a service interruption, or the like, that may be caused when the root-cause analyzing unit 34 fails to clearly recognize a layer having a root-cause.

In this case, the QoS grade of the traffic may be determined in consideration of one or more of QoS of the traffic, class of service (CoS), service level agreement (SLA), and traffic priority level. Thus, the fault recovery unit 35 may determine the QoS grade of the traffic in consideration of one or more of the QoS of the traffic, the class of service (CoS), the service level agreement (SLA), and the traffic priority level, and perform a differential fault recovery operation based on the determined QoS grade.

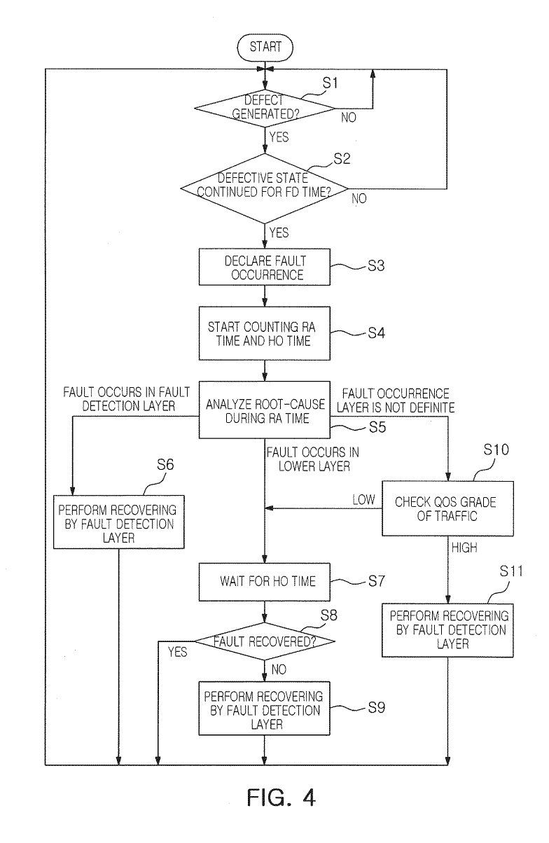

A bottom-up multilayer network recovery method based on a root-cause analysis using the multilayer fault recovery apparatus will now be described with reference to FIG. 4.

First, a defect generated from a layer employing the multilayer fault recovery apparatus is detected (step S1), and when this defective state continues for the FD time (step S2), the corresponding layer declares a fault generation (step S3).

With regard to the RA time, during which a root-cause is to be analyzed, and the HO time, during which the fault is to be recovered by a lower layer, counting is simultaneously started (step S4). In general, secondary faults occur within a very short time after the root-cause occurs, so a short time value is used as the RA time.

During the RA time, connections (i.e., correlations or associations) between the layer having the root-cause and layers having the secondary faults are analyzed based on a fault connection table such as Table 1 shown below, to recognize the layer in which the root-cause has occurred (step S5).

TABLE 1

| | Secondary |
|---|---|
| Root-cause | fault |
| Network interface fault of packet transport | N*PTi |
| layer | |
| Node fault of packet transport layer | N*PTi |
| Cutoff of optical cable between optical | M*OTi, N*PTi |
| transport layers or trouble with WDM/DWDM | |
| equipment | |
| Node fault of optical transport layer | M*OTi, N*PTi |
| Cutoff of optical cable between packet | M*OTi, N*PTi |
| transport layer and optical transport layer | |
| Fault of particular optical channel between | N*PTi |
| packet transport layer and optical transport | |
| layer | |

Table 1 shows the connections between root-cause potentially generated from each factors of the optical transmission (ROADM) and packet transmission (PBT/PBB-TE or T-MPLS/MPLS-TP) networks and secondary faults generated from the packet transport layer.

In Table 1, N*PTi indicates the generation of N number of faults of the PTL Tunnel (i.e., the path of the packet transport layer) level, and M*OTi indicates the generation of M number of faults of the OTL Tunnel (i.e., the path of the optical transport layer).

For example, when a network interface fault of the PTL node on the PTL Tunnel path is a root-cause, N*PT number of secondary faults occur at the PTL Tunnel level, and when an optical cable is cut off or when an OTL node fault occurs, M*OTi number of secondary faults occur at the OTL Tunnel level and N*PTi number of secondary faults occurs in the PTL Tunnel level.

When it is confirmed that a root-cause has been generated at the fault detection layer according to the operation results of step S5, the fault detection layer immediately recovers the fault without waiting for the HO time to expire (step S6).

Meanwhile, when it is confirmed that a root-cause has been generated at a lower layer of the fault detection layer, the fault detection layer waits for the lower layer having the root-cause to recover the fault during the HO time (step S7). If the lower layer fail to recover the fault until when the HO time lapses, the fault detection layer recover the corresponding fault (step S9).

There may be a case in which a layer in which a root-cause has occurred is not clearly recognized in spite of the performing of the root-cause analysis in step S5. In this case, in an exemplary embodiment of the present invention, a fault recovery method is determined in consideration of the quality of service (QoS) grade of traffic. This aims to perform a reliable operation even when a layer having a root-cause is not clearly recognized.

Namely, when a layer having a root-cause is not indefinite in step S5, the QoS grade of traffic is checked (step S10).

When the QoS grade of the traffic is higher than a pre-set value (namely, when the traffic has a high QoS grade), the fault detection layer immediately recovers the fault for a rapid recovery (step S11). When the QoS grade of the traffic is lower than the pre-set value (namely, when the traffic has a low QoS grade), the lower layer having the possibility of generating a root-cause is allowed to perform recovery during the HO time, and if the fault is not recovered at the lower layer, the fault detection layer recovers the fault (steps S7 to S9).

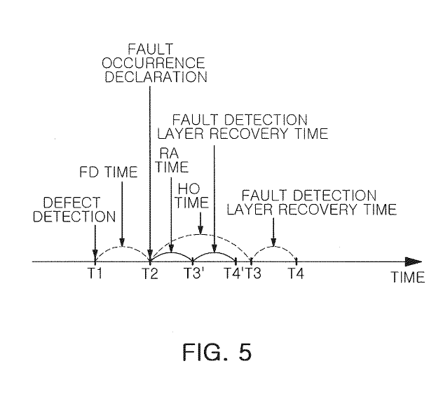

FIG. 5 is a view illustrating a recovery cycle of the bottom-up multilayer network recovery method based on a root-cause analysis according to an exemplary embodiment of the present invention.

With reference to FIG. 5, in an exemplary embodiment of the present invention, when a fault generation is declared, the RA time during which a root-cause analysis is to be performed and the HO time during which the fault detection layer wants for the lower layer is to perform recovery are simultaneously counted (T2).

When it is determined that a root-cause has been generated from the upper layer (or the fault detection layer which has detected a generated fault) according to the root-cause analysis during the RA time, the fault detection layer immediately starts recovering the fault, without waiting for the Ho time ((T3′) (T3′<T3)).

Meanwhile, when it is determined that the root-cause has been generated from the lower layer, the fault detection layer waits for the HO time at a time T3 as in the related art, and only when the lower layer fails to recover the fault, the upper layer recovers the fault during a recovery operation (RO) time (T4).

In this manner, when the upper layer has caused the root-cause, the upper layer is prevented from unnecessarily waiting for the HO time in advance, thereby reducing the time T4′ required for completing the recovery.

In the bottom-up multilayer network recovery method based on a root-cause analysis according to an exemplary embodiment of the present invention, the HO time is an important parameter affecting the recovery time. The HO time has the characteristics that it has a value increasing toward the upper layer because the upper layer must wait for the lower layer to recover the fault.

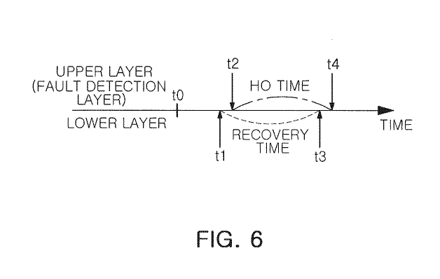

FIG. 6 is a view illustrating the relationship between a point in time at which a fault occurrence is declared and a recovery time in order to determine a hold-off (HO) time by an upper layer.

With reference to FIG. 6, the HO time in the upper layer is determined by Equation 1 shown below:

HO=Rt−Dt+Gt

Dt=t2−t1

Gt=t4−t3 [Equation 1]

Here, Rt is a time required for the lower layer to recover a fault, t0 is a point in time at which a fault is detected, t1 is a point in time at which the lower layer declares a fault generation, t2 is a point in time at which the upper layer declares a fault generation, t3 is a point in time at which a completion of the recovery of a fault is anticipated, and t4 is a point in time at which the counting of the HO time in the upper layer is terminated.

Namely, because the upper layer cannot exactly know when the lower layer will complete the recovery, it must determine whether or not its fault has been solved at the point in time t4, subsequent to the point in time t4 at which the recovery at the lower layer is anticipated to be completed, and the HO time is determined in consideration of this.

For example, in the HO time value at the PTL layer (e.g., PBB-TE), Rt, a fault recovery time of the optical cable or the PTL Tunnel level, is approximately 50 ms. When a fault occurs during the time t0 at the OTL layer (e.g., ROADM), it takes some 45 ms for the PTL layer to declare a failure by a CCM (Connectivity Check Message) of an Ethernet OAM, and it takes some 10 ms for the OTL layer to declare a failure after detecting a fault. Thus, the PTL layer must allocate a minimum 35 ms for Dt. Also, the PTL layer checks whether or not the fault in the upper layer after the recovery time of the OTL layer has been resolved after an extra time Gt. Namely, a minimum HO time at the PTL layer must be a value obtained by adding Gt to 15 ms obtained by subtracting Dt from 50 ms, the recovery time Rt at the optical layer.

An application example of the bottom-up multilayer network recovery method based on a root-cause analysis of FIG. 4 will now be described in more detail with reference to Table 2 to help understand the present invention.

In addition, for the sake of convenience of description, hereinafter, only the multilayer network recover method at the view point of the PTL node a in FIG. 2 will be described in detail, and in this case, it is assumed that the PTL Tunnel formed by connecting the PTL nodes a-e-d includes the OTL Tunnel1 (a-A-E-e) and the OTL Tunnel2 (e-E-D-d).

In an exemplary embodiment of the present invention, the multilayer network recovery method may be classified into a trigger type recovery method, a standby type recovery method (in standby until such time as an HO timer expires), and an adaptive type recovery method.

In the trigger type recovery method, a root-cause is generated at the fault detection layer, so the fault detection layer immediately starts recovering the fault (which corresponds to step S5 in FIG. 40. In the standby type recovery method, because a root-cause has been generated at the lower layer of the fault detection layer, the fault detection layer waits for the lower layer to recover the fault (which corresponds to steps S6 to S8 in FIG. 4). In the adaptive type recovery method, when it is not clear whether or not a layer in which a root-cause has been generated is the fault detection layer or the lower layer, a different recovery method is applied according to the QoS grade of traffic (which corresponds to steps S9 and S10 and S6 to S8 in FIG. 3).

TABLE 2

| | Fault of | | |
|---|---|---|---|
| | lowermost | | |
| | level | | Multilayer |
| First | detected | | network |
| detected | during RA | | recovery |
| fault | time | Root-cause | method |
| S1 | — | Particular | Trigger S1 |
| | | BSI or PW | |
| | | fault | |
| | N*Si | Fault of PTL | Adaptive type |
| | | Tunnel level | |
| | | or OTL Tunnel | |
| | | level | |
| PT1 | — | Fault of | Trigger PT1 |
| | | particular | |
| | | Tunnel | |
| | N*PTi | Fault of NIC | Adaptive type |
| | | of e/d or | |
| | | node or | |
| | | optical layer | |
| | | fault between | |
| | | E and D | |
| | OT1 | Optical | Trigger OT1, |
| | | channel fault | Standby N*PTi |
| | | between a-A- | |
| | | E-e | |
| | M*OTi | Optical | Standby |
| | | channel fault | M*OTi, |
| | | between a-A- | Standby N*PTi |
| | | E-e or fault | |
| | | of A or E | |
| | OPhy1 | Optical layer | Trigger |
| | | fault between | OPhy1, |
| | | a-A | Standby M*OTi/ |
| | | | N*PTi |
| OT1 | — | Optical | Trigger OT1 |
| | | channel fault | |
| | | between a-A- | |
| | | E-e | |
| | N*PTi | Optical | Trigger OT1, |
| | | channel fault | Standby N*PTi |
| | | between a-A- | |
| | | E-e | |
| | M*OTi | Optical | Standby M*OTi/ |
| | | channel fault | N*PTi |
| | | between a-A- | |
| | | E-e or fault | |
| | | of A or E | |
| | OPhy1 | Optical layer | Trigger |
| | | fault between | OPhy1, |
| | | a-A | Standby M*OTi/ |
| | | | N*PTi |
| OPhy1 | — | Optical layer | Trigger OPhy1 |
| | | fault between | |
| | | a-A | |
| | M*OTi | Optical layer | Trigger |
| | | fault between | OPhy1, |
| | | a-A | Standby N*PTi |
| | OPhy1 | Optical layer | Trigger |
| | | fault between | OPhy1, |
| | | a-A | Standby M*OTi/ |
| | | | N*PTi |

In Table 2, S1, PT1, OT1 and OPhy1 indicates BSI/PW, PTL Tunnel, OTL Tunnel, and optical layer fault, which are first detected, respectively, and the optical layer fault includes a cutoff of an optical cable, a fault of an optical amplifier, or a fault of DWDM/OXC equipment.

Accordingly, when a fault first detected from the PTL node a is the PTL Tunnel (PT1) and there is no fault of a lower level detected during the RA time, the fault of the PTL Tunnel is a root-cause, so the recovery procedure of the PTL Tunnel is immediately started (Trigger PT1).

When a first detected fault is the PTL Tunnel (PT1) and a fault of the lowermost level detected during the RA time is one OTL Tunnel fault (OT1), a root-cause is an optical channel fault, so the corresponding OTL Tunnel fault (OT1) starts to be recovered and the PTL Tunnel faults (N*PTi) are awaited (Trigger OT1, Standby N*PTi).

When a first detected fault is the PTL Tunnel (PT1) and a fault of the lowermost level detected during the RA time has a plurality of Tunnel levels (N*PTi), a root-cause may be a network interface fault of the PTL node e or d or an optical layer fault between the OTL nodes, namely, between the OTL nodes E and D.

Then, the fault is recovered according to the adaptive type recovery method. Namely, in case of traffic having a high QoS grade, because there is a possibility in which a current layer has a fault, recovery is immediately started without waiting for the HO time. Meanwhile, in case of traffic having a low QoS grade, the HO time is awaited; namely, the fault of the current layer is awaited to be recovered by the recovery of the lower layer (adaptive type).

In this manner, in an exemplary embodiment of the present invention, when the layer having a root-cause is not clearly confirmed or recognized, a proper recovery operation is performed according to the QoS grade of traffic.

When a first detected fault is the OTL Tunnel (OT1) and a fault of a lower level detected during the RA time is a plurality of PTL Tunnels (N*PTi), a root-cause is an optical channel fault, so the corresponding OTL Tunnel fault (OT1) starts to be recovered and the PTL Tunnel faults (N*PTi) are awaited (Trigger OT1, Standby N*PTi).

When a first detected fault is the optical layer (OPhy1) and a fault of a lower level detected during the RA time is a plurality of OTL Tunnels (M*OTi), a root-cause is the optical layer fault, so the corresponding optical layer fault (OPhy1) starts to be recovered and the OTL Tunnel faults (M*OTi) and PTL Tunnel faults (N*PTi) are awaited (Trigger OPhy1, Standby N*PTi).

When a first detected fault is the BSI/PW(S1) and a fault of the lowermost level detected during the RA time is a plurality of BSI/PW(N*Si), a root-cause may be a PTL Tunnel level fault of an OTL Tunnel level fault. In this case, because there is a possibility in which the QoS grade is high and the upper layer (or the fault detection layer) has a fault, like the adaptive recovery of the PTL Tunnel, the corresponding fault starts to be immediately recovered without waiting for the HO time. When the QoS grade is low, it awaited for the HO time so that the fault can be recovered by the recovery of the PTL Tunnel or the OTL Tunnel.

As described above, in an exemplary embodiment of the present invention, the multilayer network recovery method is diversified into the trigger type recovery method, the standby type recovery method, and the adaptive type recovery method, so degradation otherwise caused as the fault detection layer unconditionally waits for the HO time as in the related art can be prevented.

As set forth above, according to exemplary embodiments of the invention, in the multilayer fault recovery method and apparatus applied to a communication device constituting a multilayer network, a root-cause is first recognized and recovering then starts from a layer in which the root-cause has occurred. Thus, the recovering can be quickly and accurately performed.

Namely, when the fault was caused by an upper layer, the upper layer immediately recovers the fault without waiting for an HO time, and when the fault was caused by a lower layer, the upper layer waits for the HO time during which the lower layer is to recover the corresponding fault.

Thus, when the fault was caused by the upper layer, the upper layer does not need to wait for the HO time, thus shortening the overall recovery completion time.

In addition, when the cause of the fault is not clearly recognized, a differential fault recovery operation is performed according to a QoS grade of traffic in order to prevent or minimize damage such as a service interruption, or the like.

While the present invention has been shown and described in connection with the exemplary embodiments, it will be apparent to those skilled in the art that modifications and variations can be made without departing from the spirit and scope of the invention as defined by the appended claims.

What is claimed is:

1. A bottom-up multilayer network recovery method based on a root-cause analysis, the method comprising:
simultaneously counting, by a fault detection layer, a root-cause analysis (RA) time and a hold-off (HO) time, upon detecting an occurrence of a fault;
performing, by the fault detection layer, a root-cause analysis during the RA time to recognize a layer in which a root-cause has occurred;
when the root-cause has occurred in the fault detection layer, immediately recovering the fault by the fault detection layer, and when a root-cause has occurred in a lower layer, waiting for the HO time until such time as the lower layer can recover the fault; and
when the fault has not been recovered even after the HO time has lapsed, recovering the fault by the fault detection layer.

2. The method of claim 1, wherein, in the recognizing of the layer in which the root-cause has occurred, recognizing whether or not the root-cause has occurred in the fault detection layer or in the lower layer of the fault detection layer by analyzing a connection between the layer in which the root-cause has occurred and a layer in which a secondary fault has occurred.

3. The method of claim 1, further comprising:
when the layer in which the root-cause has occurred is not recognized according to the root-cause analysis results, checking a quality of service (QoS) grade of traffic;
when the QoS grade of the traffic is higher than a pre-set value, immediately recovering the fault by the fault detection layer; and
when the QoS grade of the traffic is lower than the pre-set value, determining, by the fault detection layer, whether to recover the fault after waiting for the HO time.

4. The method of claim 1, wherein the QoS grade of the traffic is determined in consideration of one or more of QoS of the traffic, class of service (CoS), service level agreement (SLA), and traffic priority level.

5. The method of claim 1, wherein the RA time is shorter than the HO time.

6. The method of claim 1, wherein the HO time is determined according to an equation: “HO=Rt−Dt+Gt, Dt=t2−t1, Gt=t4−t3”,
wherein Rt is time required for recovering the lower layer, t1 is a point in time at which the occurrence of the fault of the lower layer is declared, t2 is a point in time at which the occurrence of the fault of the lower layer is declared (or a point in time at which the upper layer starts counting of the HO time), t3 is an estimated point in time at which the recovery of the fault at the lower layer is completed, and t4 is a point in time at which the counting of the HO time by the upper layer is terminated.

7. A multilayer fault recovery apparatus applied to a communication device constituting a multilayer network, the apparatus comprising:
a fault detection unit declaring the occurrence of a fault upon detecting the fault;
a timer counting a root cause analysis (RA) time and a hold-off (HO) time when the fault detection unit declares the occurrence of the fault;
a root-cause analyzing unit recognizing a layer in which the root-cause has occurred during the RA time; and
a fault recovery unit immediately recovering a fault when the root-cause has occurred in a layer managed by the communication device, or recovering a fault only when the fault is not recovered even after the fault recovery unit waits for the HO time to allow a lower layer to recover the fault during the HO time.

8. The apparatus of claim 7, wherein when the layer in which the root-cause has occurred is not recognizable, the fault recovery unit checks the QoS grade of traffic and immediately recovers the fault with respect to traffic whose QoS grade is higher than a pre-set value, and with respect to traffic whose QoS grade is lower than the pre-set value, the fault recovery unit waits for the HO time, and then recovers the fault only when the fault is not recovered even after the lapse of the HO time.

9. The method of claim 1, wherein the fault recovery unit determines the QoS grade of the traffic in consideration of one or more of QoS of the traffic, class of service (CoS), service level agreement (SLA), and traffic priority level.
